(19) United States
(12) Patent Application Publication
(10) Pub. No.: US 2026/0073893 A1
(43) Pub. Date: Mar. 12, 2026

(54) DYNAMIC BUFFER SIZING AND HARDWARE-ASSISTED FRAME PACING WHILE APPLICATION STREAMING

(71) Applicant: NVIDIA Corporation, Santa Clara, CA (US)

(72) Inventors: Viktor VANDANOV, San Jose, CA (US); Rouslan Lyubomirov DIMITROV, Newark, CA (US); James Alexander HOWARD, Folsom, CA (US); Jithin Reddy YARATAPALLI, San Jose, CA (US)

(73) Assignee: NVIDIA Corporation, Santa Clara, CA (US)

(21) Appl. No.: 18/830,829

(22) Filed: Sep. 11, 2024

(51) Int. Cl. G09G 5/395; G09G 5/393

(52) U.S. Cl. CPC G09G 5/395; G09G 5/393; G09G 2360/18

(57) ABSTRACT

Various examples, systems, and methods are disclosed relating to buffer sizing and frame pacing. A first computing system decode an encoded bitstream of a data stream to extract a plurality of frames corresponding to a plurality of first presentation times. The first computing system can update a target buffer size of at least one buffer based on one or more deviations between one or more expected frame arrival times of the encoded bitstream and one or more actual frame arrival times. The first computing system can store the plurality of frames in the at least one buffer for scheduling presentation on a display. The first computing system can present the plurality of frames at a plurality of second presentation times on the display based on at least one tuning of the plurality of first presentation times responsive to an update in the target buffer size.

### BACKGROUND

Streaming high-quality video content in real-time presents challenges, particularly in maintaining smooth playback and visual consistency across varying network conditions. Traditional video streaming techniques often rely on static buffer sizes and fixed frame pacing methods, leading to inefficiencies and potential disruptions in video playback. These methods generally fall into two categories: fixed buffering with static frame rates and adaptive streaming with limited capabilities for handling network variability. Fixed buffering approaches are implemented with static configurations but can result in noticeable stutter or frame drops during fluctuations in network performance. Adaptive streaming techniques, while more responsive, often struggle to consistently deliver high-quality video due to constraints in effectively managing frame presentation and synchronization. These challenges impact the effectiveness of systems in delivering smooth and consistent video streams, affecting user experience in applications such as gaming, live streaming, and interactive media.

### SUMMARY

Embodiments of the present disclosure relate to the dynamic buffering and hardware-assisted frame pacing for real-time video streaming (e.g., while application streaming). In contrast to conventional systems, which exhibit limitations in maintaining smooth playback under varying network conditions, the systems and methods described herein address these limitations through dynamic buffer sizing and frame pacing techniques. The embodiments provide more accurate and responsive video streaming. For instance, the systems and methods can dynamically adjust the buffer size based on real-time network conditions, utilize tuning parameters to fine-tune frame presentation times, and employ hardware-assisted pacing to ensure synchronization with variable refresh rate displays. Furthermore, by integrating these processes and reducing reliance on static configurations, the computing systems and methods can maintain consistent video playback even in the presence of network-induced jitter and latency. This provides improved systems and methods for delivering high-quality video streaming across diverse applications.

At least one embodiments relates to one or more processors including one or more circuits. The one or more circuits are to decode an encoded bitstream of a data stream to extract a plurality of frames corresponding to a plurality of first presentation times. The one or more circuits are to update a target buffer size of at least one buffer based on one or more deviations between one or more expected frame arrival times of the encoded bitstream and one or more actual frame arrival times. The one or more circuits are to store the plurality of frames in the at least one buffer for scheduling presentation on a display. The one or more circuits are to present the plurality of frames at a plurality of second presentation times on the display based on at least one tuning of the plurality of first presentation times responsive to an update in the target buffer size.

In some embodiments, the target buffer size of the at least one buffer causes an update in a minimum frames per second (FPS) rate based on the one or more deviations in the one or more expected frame arrival times and the one or more actual frame arrival times. In some embodiments, a maximum FPS rate is selected based on a streaming mode. In some embodiments, the one or more circuits are to monitor the one or more deviations and at least one display performance metric of the display. In some embodiments, the one or more circuits are to update the maximum FPS rate based on at least one of (i) the monitored one or more deviations or (ii) the at least one display performance metric.

In some embodiments, the target buffer size of the at least one buffer is increased to approximate a first buffer size based on the one or more deviations increasing. In some embodiments, the target buffer size of the at least one buffer is decreased to approximate a second buffer size based on the one or more deviations decreasing. In some embodiments, the one or more circuits are to responsive to decoding the encoded bitstream, map the plurality of first presentation times of a first computing system to the plurality of second presentation times of the one or more processors.

In some embodiments, the plurality of frames presented at the plurality of second presentation times is presented at a second frame presenting rate. In some embodiments, the second frame presenting rate is slower or faster than a first frame presenting rate of the plurality of frames corresponding to the plurality of first presentation times. In some embodiments, the one or more circuits are to adjust a refresh rate of the display based on the second frame presenting rate. In some embodiments, the one or more circuits correspond to a display controller of the display. In some embodiments, the presenting occurs independently of a central processing unit (CPU) of a client device.

In some embodiments, a second presentation time of the plurality of second presentation times occurs before or after a corresponding first presentation time of the plurality of first presentation times provided in the encoded bitstream. In some embodiments, the one or more circuits are to store subframes of the plurality of frames in the at least one buffer, the subframes corresponding to one or more portions of at least one of the plurality of frames. In some embodiments, the tuning of the plurality of first presentation times is based on timing data of the stored subframes.

The processors, systems, and/or methods described herein can be implemented by or included in at least one a system for performing gaming; a system for performing content streaming; a system for performing collaborative content creation; a system for performing simulation operations; a system for performing collaborative content creation for 3D assets; a system for generating synthetic data; a system including one or more vision language models (VLMs); a system including one or more large language models (LLMs); a system for performing conversational AI operations; a system for performing light transport simulation; a system for performing deep learning operations; a system for performing digital twin operations; a control system for an autonomous or semi-autonomous machine; a perception system for an autonomous or semi-autonomous machine; a system incorporating one or more virtual machines (VMs); a system implemented using a robot; a system implemented using an edge device; a system implemented at least partially in a data center; or a system implemented at least partially using cloud computing resources.

At least one embodiments relates to a system, including one or more processors to execute operations. The one or more processors can execute operations to extract, from a data stream, a plurality of frames corresponding to a plurality of first presentation times. The one or more processors can execute operations to store the plurality of frames in an at least one buffer having an adaptive buffer size that is responsive to one or more deviations between expected and actual time arrival times of the data stream. The one or more processors can execute operations to present the plurality of frames at a plurality of second presentation times on a display based on at least one tuning of the plurality of first presentation times responsive to an update in the adaptive buffer size.

In some embodiments, the adaptive buffer size of the at least one buffer causes an update in a minimum frames per second (FPS) rate based on the one or more deviations between the expected and the actual arrival times of the data stream. In some embodiments, a maximum FPS rate is selected based on a streaming mode. In some embodiments, the one or more processors executing the operations are to monitor the one or more deviations and at least one display performance metric of the display. In some embodiments, the one or more processors executing the operations are to update the maximum FPS rate based on at least one of (i) the monitored one or more deviations or (ii) the at least one display performance metric.

In some embodiments, the adaptive buffer size of the at least one buffer is increased to approximate a first buffer size based on the one or more deviations increasing. In some embodiments, the adaptive buffer size of the at least one buffer is decreased to approximate a second buffer size based on the one or more deviations decreasing. In some embodiments, the one or more processors executing the operations are to decode an encoded bitstream of the data stream to extract the plurality of frames. In some embodiments, the one or more processors executing the operations are to, responsive to decoding the encoded bitstream, map the plurality of first presentation times of a first computing system to the plurality of second presentation times of the system.

In some embodiments, the plurality of frames presented at the plurality of second presentation times is presented at a second frame presenting rate. In some embodiments, the second frame presenting rate is slower or faster than a first frame presenting rate of the plurality of frames corresponding to the plurality of first presentation times. In some embodiments, the one or more processors executing the operations are to adjust a refresh rate of the display based on the second frame presenting rate. In some embodiments, the one or more processors correspond to a display controller of the display. In some embodiments, the presenting occurs independently of a central processing unit (CPU) of a client device.

At least one embodiment relates to a method. The method can include decoding an encoded bitstream of a data stream to extract a plurality of frames corresponding to a plurality of first presentation times. The method can include storing, using one or more processors, the plurality of frames in an at least one buffer having a dynamic buffer size. The method can include presenting, using the one or more processors, the plurality of frames at a plurality of second presentation times on a display based on at least one adjustment of the plurality of first presentation times responsive to an update in the dynamic buffer size and variations between predicted and actual frame arrival times of the data stream.

### BRIEF DESCRIPTION OF THE DRAWINGS

The present systems and methods for dynamic buffer sizing and hardware-assisted frame pacing for smooth presentation (e.g., while application streaming) is described in detail below with reference to the attached drawing figures, wherein:

FIG. 1 is a block diagram of an example system for performing operations on frames, in accordance with some embodiments of the present disclosure;

FIG. 2 depicts a block diagram of a frame presentation pipeline to dynamically size a buffer and perform frame pacing, in accordance with some embodiments of the present disclosure;

FIG. 3 is a flow diagram of an example of a method for buffer sizing and frame pacing, in accordance with some embodiments of the present disclosure;

FIG. 4 is a block diagram of an example content streaming system suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

This disclosure relates to systems and methods for dynamically sizing one or more buffers on a client side after receiving a decoded frame, and utilizing hardware-assisted frame pacing to present (or schedule for presentation) the frames on a client device. For instance, systems and methods in accordance with the present disclosure facilitate dynamic buffer adjustments to improve frame presentation timing, which can be used to configure and/or optimize the frame pacing (and/or subframe pacing) and presenting times on the client device. That is, configuring and/or optimizing presenting times can include tuning at least one presentation time provided in the encoded bitstream based on a tuning parameter corresponding to a target buffer size.

Some techniques for handling network-induced jitter in video streaming, such as dynamic de-jittering, do not support dynamic buffer sizing, having subframe granularity with the buffer, which often result in inconsistent frame presentation. This can result in visuals that lack smoothness and fidelity, which can be problematic in applications in gaming, real-time streaming, simulation, video conferencing, and other interactive or immersive environments where high visual quality is important. Some techniques can also fail to provide high-quality frame pacing; while they can utilize fixed buffer sizes, these techniques can fail to achieve a target level of detail and visual consistency. The limitations relate to how these methods handle buffer size adaptation, frame pacing accuracy, and network variability. For instance, poor buffer size management can lead to noticeable frame drops or stutter, disrupting the continuity of the video playback. Frame pacing (e.g., while application streaming) issues can also arise when frames are not presented in sync with the intended display rate, resulting in jittery motion or lag. Additionally, inadequate buffer management can prevent these systems from adapting to varying network conditions, leading to a loss of quality during periods of network variability. The improved embodiments described herein controls dynamic de-jittering by adjusting the frame time durations having subframe granularity programmed to the display hardware of the client and leveraging variable refresh rate displays, eliminating or reducing stutter and latency.

Systems and methods in accordance with the present disclosure can allow for improved accuracy and smooth frame and/or subframe scheduling on client devices by using a dynamic buffer and hardware-assisted frame pacing technique. For instance, a plurality of frames can be dynamically buffered based on real-time network conditions and presented at an improved pace using dedicated hardware components. These components can manage the buffer size to maintain consistent frame arrival and presentation times, ensuring smooth playback.

The systems and methods in accordance with the present disclosure also include presenting the plurality of frames at a plurality of second presentation times on the variable refresh rate display of a client device based on a tuning parameter. For instance, the first presentation times can be adjusted by the tuning parameter in response to updates in the target buffer size and/or storing frames in a buffer having an adaptive buffer size, which can be based on timing deviations during frame transmission (e.g., network latency or other network timing metrics). The deviations can refer to a difference or delta in the expected versus actual frame arrival times. For instance, a network timing metric (e.g., historical round-trip time (RTT) measurements, predefined network parameters, and/or any metrics or models used to forecast latency in a networked environment) can be used to determine the expected frame arrival time. Additionally, this adjustment process modifies the client presentation times, scheduling frames to be presented at the appropriate times on the client device, maintaining smooth playback and synchronization with the variable refresh rate display.

In some embodiments, a game presenting rate can be capped to the maximum display refresh rate on the client device. For instance, a server can record the frame time of one or more (e.g., each) frames, and the client device can utilize dedicated hardware components and tuning described herein to present the frames to the user with the same or adjusted timing the server used for rendering, using a variable refresh rate display. Additionally, systems and methods in accordance with the present disclosure also include loading (or filling) or removing (or draining) frames from the frame queue de-jitter buffer on the client device by adjusting the timestamps. For instance, the frames can be displayed for a slightly longer duration to fill the buffer, or for a slightly shorter duration to drain the buffer, which can be implemented through the timestamp adjustments and the tuning parameter. That is, the tuning parameter can modify (or tune) the presentation times of the frames on the client device to either extend or reduce the display duration of one or more frames, attempting to maintain or achieve the target buffer size in response to network conditions or other timing deviations. For instance, if the buffer needs to be filled (e.g., when the actual frame arrival rate is slower than expected), the tuning parameter can delay the presentation of frames slightly, extending their display duration and allowing more time for subsequent frames to arrive; conversely, if the buffer needs to be drained (e.g., when the actual frame arrival rate is faster than expected), the tuning parameter can advance the presentation times, reducing the display duration and preventing the buffer from overflowing.

In some embodiments, a plurality of frames can be buffered and scheduled for presentation based on dynamic adjustments to the buffer size, such as to optimize frame pacing and minimize jitter. The buffer size can be adjusted dynamically in response to network-induced jitter, facilitating finer control over frame presentation timing. For instance, if frames arrive with varying intervals, the buffer can be increased or decreased in size by small increments (e.g., 5 ms) to maintain a consistent presentation schedule—thereby tuning the presentations times. Hardware-assisted frame pacing can then be used to present the buffered frames at the desired display refresh rate, such as 40 Hz, 120 Hz, or higher, depending on the streaming mode. In some embodiments, systems and methods can also map server-provided presentation times to client presentation times to maintain synchronization with the variable refresh rate of displays of client devices.

The dynamic buffer sizing and hardware-assisted frame pacing method can be used to present frames (or schedule for presentation) on the client device in various manners. For instance, the buffer size can be increased if frame arrival times become more variable, or decreased if frame arrival times stabilize. This dynamic adjustment, using tuning parameters, can help facilitate the presentation of frames at correct (or desired) times (e.g., the frame time recorded by the server can be adjusted, when, for instance, the de-jitter queue needs to drain or fill), minimizing visual artifacts and enhancing playback quality. Various objectives can facilitate realistic and efficient frame presentation, such as optimizing the buffer size for visual and performance consistency. The hardware-assisted frame pacing can allow the display to render frames at a speed the display sets and paces.

The systems and methods described herein can be used for a variety of purposes, by way of example and without limitation, for enhancing real-time gaming experiences, improving video streaming services, supporting high-quality interactive media applications, and optimizing the performance of client devices under varying network conditions. Moreover, these methods can improve the visual quality and consistency of streamed content, providing a better user experience across different network conditions and device capabilities.

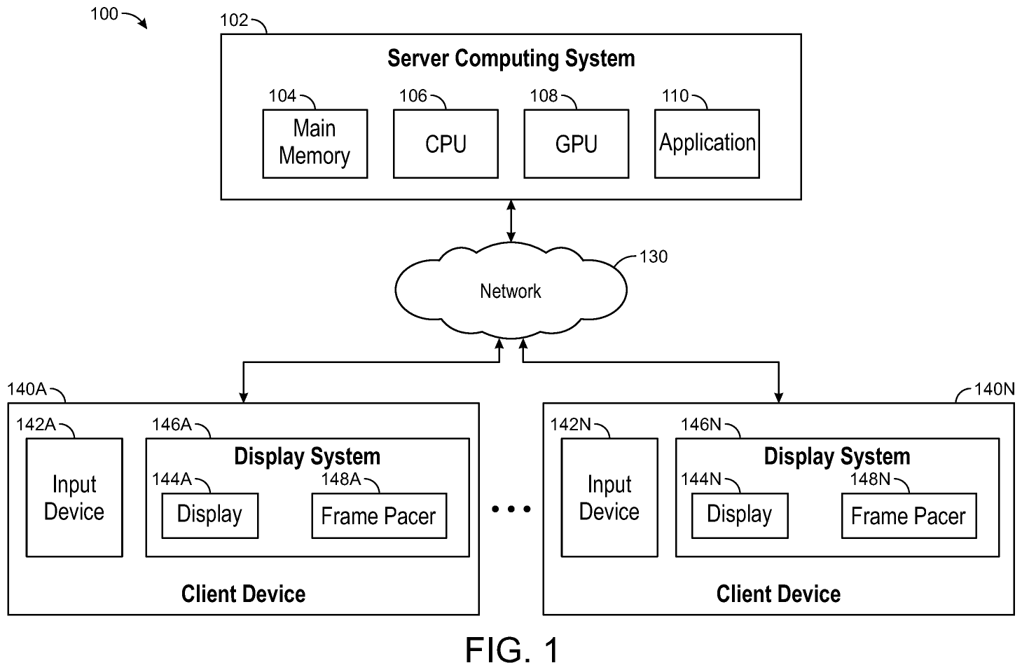

With reference to FIG. 1, FIG. 1 is an example system 100 for performing operations on frames, in accordance with some embodiments of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by entities can be carried out by hardware, firmware, and/or software. For instance, various functions can be carried out by a processor executing instructions stored in memory. These components interact to facilitate the dynamic buffer sizing and frame pacing and/or subframe pacing.

As depicted in FIG. 1, system 100 can include multiple computing devices, including at least one server computing system 102 (also referred herein as server machine 102) connected via a network 130 to client devices 140A . . . 140N. In some embodiments, the server computing system 102 can be a server of a streaming service such as a cloud gaming service (e.g., gaming-on-demand center or gaming-as-a-service center). For instance, the server computing system 102 can provide a type of online game that runs a game application 110 remotely on the server machine 102 and streams game content directly to client devices 140A . . . 140N. Although a reference throughout the present disclosure can often be made to game applications, application 110 can be or include any other application which renders and streams data to a device that displays that data, e.g., client devices 140A . . . 140N. Although FIG. 1, for the sake of illustration, depicts client devices 140A . . . 140N that are communicating to server computing system 102 via network 130, the implementations and embodiments of the present disclosure can also be applicable to applications 110 that are run on a single, e.g., local, computer that renders images and then displays the rendered images on a local monitor. Various processes and operations of application 110 can be executed and/or supported by a number of processing resources of server computing system 102, including main memory 104, one or more central processing units (CPUs) 106, one or more graphics processing units (GPUs) 108, and/or various other components that are not explicitly illustrated in FIG. 1, such as wireless modems, network cards/controllers, local buses, graphics cards, parallel processing units (PPUs), data processing units (DPUs), accelerators, and so on.

Some or all client devices 140A . . . 140N can include respective input devices 142A . . . 142N and displays 144A . . . 144N. An input device can include any device capable of capturing a user input, such as a keyboard, mouse, gaming console, joystick, touchscreen, stylus, camera/microphone (to capture audiovisual inputs), and/or any other devices (or computing systems) that can detect a user input. The terms “monitor,” “display,” and “screen,” as used herein (collectively referred to herein as “display devices”), should be understood to include any device from which images and/or media can be perceived by a user (e.g., gamer), such as an LCD monitor, LED monitor, CRT monitor, plasma monitor, including any monitor communicating with a computing device either wirelessly or via an external cable (e.g., HDMI cable, VGA cable, DVI cable, DisplayPort cable, USB cable, and/or the like), or any monitor communicating with a computing device (e.g., an all-in-one computer, a laptop computer, a tablet computer, a smartphone, and/or the like) via an internal cable or bus. In some embodiments, one or more display devices can implement a variable reference rate (VRR) image transmission scheme, allowing the display device (or an external system) to adjust its refresh rate (e.g., based on the frame rate of the video source). Additionally, display devices should also include any augmented/mixed/virtual reality device (e.g., glasses), wearable device, and/or the like. In some embodiments, any, some, or all displays 144A . . . 144N can be variable reference rate (VRR) displays, which can be used to detect frame rate of the video content provided to the display and dynamically adjust the refresh rate of the display.

Application 110 can cause server computing system 102 to generate data (e.g., video frames that can be encoded into a bitstream) that can be to be displayed on one or more displays 144A . . . 144N. A set of operations that begins with data generation and concludes with presenting (sometimes referred to as “displaying”) the generated data can be referred to as the frame presentation pipeline herein. The frame presentation pipeline can include operations performed by server computing system 102, e.g., a rendering stage, a capturing stage, an encoding stage, a packetizer stage, and/or a transmission stage. In some embodiments, the frame presentation pipeline can also include a transmission stage that includes the transmission of packets of data packetized by server computing system 102 via network 130 (or any other suitable communication channel). The frame presentation pipeline can further include operations performed by a client device 140X (e.g., client device 140A . . . 140N), such as operations of a depacketizer stage, a decoding stage, a buffer stage, and a presentation stage. The operations of the frame presentation pipeline on client device 140X can be supported by a respective display system 146X (e.g., display system 146A . . . 146N).

The rendering stage can refer to the stage in the pipeline in which video frames (e.g., the video game output) are rendered on server machine 102 according with a certain frame rate that can be set, e.g., based on the game engine requirements, network conditions, or system performance. For instance, the frame rate can be dynamically adjusted to optimize performance and visual quality. The frame capture stage can refer to the stage in the pipeline in which rendered frames are captured (e.g., immediately) after being rendered. For instance, frames can be captured directly from the GPU framebuffer before any post-processing. The frame encoding stage can refer to the stage in the pipeline in which captured frames of the video are compressed using any suitable compressed video format, e.g., H.264, H.265, VP8, VP9, AV1, or any other suitable video codec formats. For instance, the frames can be encoded using a hardware encoder or software-based compression, depending on the system configuration. The frame packetizer stage can refer to the stage in the pipeline in which the compressed video format is partitioned into packets for transmission over network 130. For instance, the packetizer can add headers and sequence numbers to ensure proper data reconstruction at the client device.

In some embodiments, the frame depacketizer stage can refer to the stage in the pipeline in which the plurality of packets is assembled into the compressed video format on client device 140X. For instance, an encoded bitstream of a video stream can be reconstructed by reordering and combining the received packets based on sequence numbers. The frame decoding stage can refer to the stage in the pipeline in which the compressed video format is decompressed into the frames. For instance, the encoded bitstream can be decoded using a hardware decoder, such as a GPU-accelerated decoder, or a software-based decoder, depending on the client device 140X configurations. Additionally, in some embodiments, before the packets are sent over the network, the packetizer can add forward error correction (FEC) by inserting redundant packets into the data stream. For instance, if every 10 packets contain 8 data packets and 2 FEC packets, the client device (e.g., client device 140X) can reconstruct any missing data packets if up to 2 packets are lost during transmission.

In some embodiments, the frame buffer stage can refer to the stage in the pipeline in which the frames and/or subframes are populated (e.g., queued) into a buffer to prepare for display. That is, subframes can include fractional segments of a frame corresponding to specific time intervals (e.g., 0.5 ms segments of frame data). For instance, to populate a buffer with subframes, the frame buffer stage can include dividing or fractionalizing a frame into smaller time-based segments and store the segments in the buffer. The frame buffer stage can also refer to updating the target buffer size of the buffer based on one or more deviations (e.g., delta or difference) in the expected frame arrival time from the server computing system 102 and the actual frame arrival of the encoded bitstream. In some embodiments, the buffer can be dynamically sized to regulate or control consistent frame pacing. For instance, the buffer size can be adjusted incrementally to smooth out irregular frame arrival intervals. That is, the expected frame arrival time can be determined or calculated based on at least one network timing metric. For instance, network latency, jitter, or packet loss rates can be used to predict the expected frame arrival time. In some embodiments, the frame buffer stage can include storing the frames and/or subframes in the buffer for scheduling presentation (e.g., on a VRR display).

In some embodiments, the presentation stage can refer to the stage in the pipeline in which frames are presented (or displayed) on display 144X of display system 146X. That is, timestamps can already be attached to the frames and the computer hardware can be updated (e.g., the display device) according to the timestamp. In some embodiments, the presentation of the frames can occur at a plurality of presentation times based on a tuning parameter. That is, presentation times identified in the encoded bitstream can be tuned responsive to update in the target buffer size set in the frame buffer stage. For instance, the tuning parameter can delay the presentation time to increase the number of frames in the buffer. In another instance, the tuning parameter can advance the presentation time to reduce the number of frames in the buffer. That is, the target buffer size is determined to control frame pacing and synchronization, and the tuning parameter can adjust the presentation times to align the buffer size with this target. Thus, the display system 146X can employ a hardware-assisted frame pacing method that can provide a bare-metal experience (e.g., during gaming) by minimizing latency, reducing input lag, and ensuring smooth and consistent frame delivery through the hardware without relying heavily on software-based processing.

Additionally, the hardware-assisted frame pacing method can dynamically adjust the frame presentation rate based on the refresh rate (e.g., 60 Hz, 120 Hz, 240 Hz) of the display and the current buffer state. That is, the display system 146X can control frame pacing, adapting to real-time conditions to minimize latency and stutter. By adjusting the presentation timing according to the capabilities and buffer status of the display, frames can be presented in sync with the variable refresh rate.

Some or all display systems 146A . . . 146N of respective client devices 140A . . . 140N can include a frame pacer component 148A . . . 148N that can update a target buffer size of a buffer. Additionally, some or all display systems 146A . . . 146N of respective client devices 140A . . . 140N can include a frame pacer component 148A . . . 148N that can store the plurality of frames in an at least one buffer having an adaptive buffer size that is responsive to one or more deviations between expected and actual time arrival times of the data stream. The target (or adaptive) buffer size can be set based on a deviation (e.g., difference or delta) between an expected frame arrival time of the encoded bitstream and the actual frame arrival time. That is, the frame pacer component 148X can adjust the target buffer size dynamically based on, for instance, real-time deviations between expected and actual frame arrival times. For instance, if the actual frame arrival time is consistently (or during a particular period of time) earlier or later than expected, the frame pacer component 148X can increase or decrease the target buffer size to compensate.

In some embodiments, based on the target buffer size, a tuning parameter can be determined and/or tuning can be performed to pace the frames. That is, pacing the frames can include adjusting (e.g., tuning) the timing of frame presentation to either delay or advance the display of frames, thereby regulating the buffer size. For instance, the frame pacer component 148X can update a target buffer size and/or store the frames in a buffer having an adaptive buffer size to ensure that frames are presented in a manner that minimizes stutter or latency. In this instance, the frame pacer component 148X can present the frames at presentation times on the display 144X of the display system 146X. That is, the hardware-assisted frame pacing while application streaming can be integrated within a display system 146X such that the frame presentation timing is adjusted by the display hardware in real-time (e.g., control or processing circuit of display system 146X), based on the updated target buffer size and/or adaptive buffer size. Additionally, the frame pacer component 148X can modify the presentation timing to align with the updated target buffer size, ensuring that frames are displayed at intervals that support smooth playback and maintain synchronization with the variable refresh rate of the display 144X.

That is, instead of the presentation being set by the server or cloud computing system, the frame pacer component 148X dynamically controls the presentation timing on the client side. The frame pacer component 148X can adjust the timing based on real-time conditions such as buffer size, network latency, and display refresh rate, synchronizing the frame presentation with the capabilities of the display and adapting to variations in network performance and rendering speed (e.g., independent of the original timing parameters provided by the server). The various presentation times can be tuned responsive to the update in the target buffer size such that the frames are displayed at intervals that maintain smooth playback and synchronization with the display refresh rate of display 144X.

Some or all display systems 146A . . . 146N of respective client devices 140A . . . 140N can include a display 144A . . . 144N that can present one or more frames at one or more presentation times based on at least one tuning of the original presentation times responsive to an update in the target buffer size. For instance, tuning can be performed based on one or more tuning parameters. In some embodiments, the tuning parameter can be used to advance and/or delay the frame presentation times. That is, the tuning parameter can facilitate the smooth playback on the display 144A . . . 144N by compensating for variations in frame arrival times and aligning the frame presentation with the current network conditions and processing capabilities.

Additionally, frame pacer component 148A . . . 148N can collect various metrics that characterize operations of the frame presentation pipeline on the respective client device 140X. The metrics can include, but are not limited to, network timing metrics, an average refresh rate of display 144X, a noise (jitter) of the refresh rate of display 144X, specific timestamps corresponding to the times when display 144X begins displaying individual frames, the times when display 144X finishes displaying individual frames, and/or various other metrics. That is, the network timing metrics can be information used to predict network latency, such as historical round-trip time (RTT) measurements (e.g., previous frame delivery times and packet transmission delays), predefined network parameters (e.g., maximum transmission unit (MTU) size, bandwidth limitations, packet loss rate), and/or any metrics or models used to forecast latency in a networked environment. The network timing metrics can be used by the frame pacer component 148X to estimate how long it is expected to take for a data packet, like a video frame, to travel from the server computing system 102 to the client device 140X. For instance, the expected frame arrival time can be calculated based on historical RTT measurements and/or current network conditions based on an average of recent packet delivery times and current latency trends.

In some embodiments, the metrics collected by a frame pacer component 148X on the side of client device 140X can be provided to the server computing system 102. The frame pacer component 148X can further collect various additional metrics on the side of the server computing system 102, including but not limited to average and/or per-frame time for CPU processing TCPU, average and/or per frame time for GPU rendering TGPU, average and/or per-frame time of delivering a frame to display 144X (which can include time for packetizing/depacketizing of individual frames and time spent in network transmission of the packets). In some embodiments, metrics collected by frame pacer component 148X can track frame processing at one, some, or all the stages of the frame presentation pipeline and can be used to pace frame presentation (e.g., delay or advance) to minimize latency in frame processing along the pipeline. For instance, the frame pacer component 148X can adjust the frame presentation timing on client device 140X based on real-time (or near real-time) processing metrics to minimize latency and provide smooth frame delivery in the frame presentation pipeline.

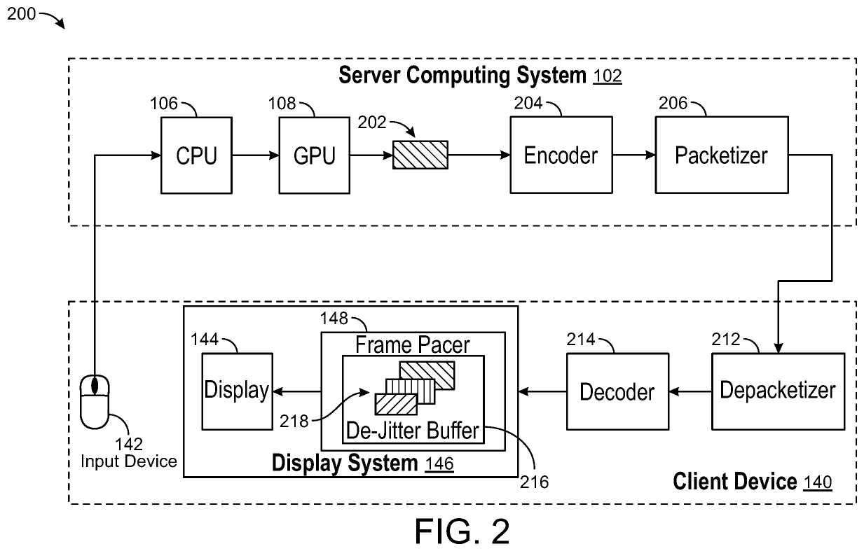

Now referring to FIG. 2, a block diagram of a frame presentation pipeline 200 to dynamically size a buffer and perform frame pacing, in accordance with some embodiments of the present disclosure. The frame presentation pipeline 200 can support operations of a suitable image-generating application (e.g., application 110 in FIG. 1) on server computing system 102. The application (e.g., a gaming application) can use one or more processing circuits to render video frames. For instance, CPU 106 can process user inputs captured by input device 142 of client device 140, update the current state of the application (e.g., game), perform simulations of new content (e.g., images, scenes, and/or context) to be rendered (e.g., in view of specific distances traveled by various game objects, angles to which the objects have turned, and/or like), and generate rendering instructions for GPU 108.

In some embodiments, the CPU 106 can provide instructions to the GPU 108 to process. For instance, the CPU 106 can instruct the GPU 108 to render specific objects or scenes based on the game state and user inputs, and to apply certain graphical effects or transformations. GPU 108 can execute the instructions from the CPU 106 (e.g., queued or in a set of instructions) and render the scheduled content (e.g., by rasterizing and shading pixels) to generate rendered frames 202. For instance, the GPU 108 can rasterize 3D models into 2D images, apply textures, lighting, and shading effects, and output the final rendered frames ready for encoding. In some embodiments, individual (or a collection) of rendered frames 202 can be immediately (or near-immediately) encoded by encoder 204, packetized by the packetizer 206, and communicated to the client device 140. That is, the encoding and packetizing can occur as soon as rendering by GPU 108 is performed (e.g., to output the rendered frames 202). For instance, the encoder 204 can encode individual rendered frames 202 from a video game format to a digital format (e.g., for packetization and transmission). In some embodiments, once the frame is rendered by the encoder 204, packetizer 208 can packetize the encoded frame for transmission over network (e.g., network 130 of FIG. 1, not explicitly depicted in FIG. 2). Packetizing encoded frames can include partitioning the encoded frames into a plurality of packets (e.g., formatted units of data). For instance, the packetizer 208 can partition the encoded frames into packets that include headers for error checking and sequence information to facilitate reassembly at the client device 140.

Network transmission of packets to client device 140 can cause some of the packets to be lost or delayed (e.g., network jitter). Additionally, packets can arrive out of order due to varying network conditions (e.g., requiring reordering by the client device 140). That is, the packets received by client device 140 can be processed by a depacketizer 212 that depacketizes the encoded bitstream of frames. For instance, an encoded bitstream of a video stream can be depacketized by reassembling the packets in the correct order to reconstruct the original encoded frame data. In some embodiments, once the encoded bitstream (e.g., of encoded frames) is assembled from one or more packets, decoder 214 can decode the encoded frame. For instance, the decoder 214 can decode the encoded bitstream to extract a plurality of frames corresponding to a plurality of presentation times. In this instance, the frames can be buffered, paced, and/or scheduled for presentation (or display) at the appropriate times based on the presentation timing information extracted during the decoding process, the target buffer size, and the tuning parameter.

Referring to the frame pacer 148 in greater detail, the frame pacer 148 can include or be coupled with a buffer, such as de-jitter buffer 216 (also referred to as “dejitter buffer 216”). In some embodiments, the de-jitter buffer 216 can be dynamically sized at a subframe-level, such that the de-jitter buffer 216 can be used to introduce a tuned delay before a video frame is rendered on the display. For instance, the delay can range from a few milliseconds to longer periods based on one or more real-time assessments of network conditions and client device performance (e.g., available bandwidth, processing power). For instance, where full frames are not buffered, a fractional delay—such as a half-frame delay—can be utilized to absorb partial frame jitter caused by network variability. The frame pacer 148 can update a target buffer size of at least one buffer based on one or more deltas (or differences, deviations) between one or more expected frame arrival times of the encoded bitstream and one or more actual frame arrival times. That is, the delta can be used to update the target buffer size to dynamically size the de-jitter buffer 216. Generally, referring to how the target buffer size can be used to dynamically size the de-jitter buffer 216, the target buffer size influences the application of the tuning parameter, which can be used by the frame pacer 148 to adjust the timing of frame presentations, thereby controlling buffer occupancy. The tuning parameter can be applied to modify the presentation times. In some embodiments, the tuning parameter can be derived from the rate of change in the delta (difference or deviation) between the expected and actual frame arrival times.

In some embodiments, the delta can be the difference between the expected frame arrival time and the actual frame arrival time (e.g., difference occurs due to network variability, such as latency or jitter). Additionally, the rate of change of the delta over time (the derivative) can represent how quickly or slowly the deviation is changing (e.g., influenced by worsening or improving network conditions). In some embodiments, the tuning parameter can be derived from the rate of change in the delta (e.g., used to adjust the timing of frame presentations, which influences the buffer occupancy). Additionally, the de-jitter buffer 216 can also be adjusted at a subframe level, where the buffer can absorb or releases fractions of a frame (e.g., 0.5 ms increments) to manage jitter. That is, the tuning parameter can be used to modify the presentation times in a way that moves the actual buffer occupancy closer to the target buffer size. For instance, if the buffer occupancy is below the target, the tuning parameter can be used by the frame pacer 148 to delay presentation times to increase the buffer occupancy of the de-jitter buffer 216. In another instance, if the buffer occupancy exceeds the target, the tuning parameter can be used by the frame pacer 148 to advances presentation times to reduce the buffer occupancy of the de-jitter buffer 216. Subframe adjustments can occur to correct for timing variations in frame delivery, allowing the buffer size to be incrementally adjusted based on real-time conditions. As shown, the frame pacer 148 can approximate the buffer occupancy by dynamically adjusting the buffer size toward the target buffer size as determined by real-time conditions and tuning parameter adjustments. In some embodiments, the decoded frames 218 can be stored in a de-jitter buffer 216. Multiple decoded frames 218 can be maintained in de-jitter buffer 216 based on the tuning parameter.

In some embodiments, the encoder 204 processing rendered frames 202 can be a software-implemented encoder or a dedicated hardware-accelerated encoder configured to encode data substantially compliant with one or more data encoding formats or standards, including, without limitation, H.263, H.264 (AVC), H.265 (HEVC), H.266, VVC, EVC, AVC, AV1, VP8, VP9, MPEG4, 3GP, MPEG2, and/or any other video or multimedia standard formats. Encoder 204 can encode rendered frame 202 by converting the frame from a video game format to a digital format (e.g., H.264 format).

Packetizer 206 can packetize the encoded frame for transmission over a network (e.g., network 130 in FIG. 1) via a suitable network controller (network card, etc.). Packetizing the encoded frame can include partitioning the encoded frame into a plurality of packets (e.g., formatted units of data) to be carried by the network. In some embodiments, a high frame rendering rate of frames 202 (e.g., 180 Hz, 240 Hz or higher) can ensure that individual frames 202 are small enough to be transmitted via a single packet. The network controller of server computing system 102 can transmit the packets via the network to a network controller of client device 140. Due to network jitter, some of the transmitted packets can be lost in transmission or can take longer to be received by the client device 140. In some instances, a newer frame can take a different route (within the network) than an older frame and arrive earlier than the older frame.

In some embodiments, client device 140 can receive the packetized encoded frame via its network controller and process the received packets using depacketizer 212 and decoder 214. In some embodiments, decoder 214 can be a software-implemented decoder or a dedicated hardware-accelerated decoder decoding data according to the video encryption standard used by encoder 204. Additionally, the decoded frames 218 can be stored in de-jitter buffer 216 by the frame pacer 148. In some embodiments, a subframe (e.g., a portion of a frame including timing data that corresponds to a fraction of the total frame data, such as 0.5 ms of the frame duration) of decoded frame 218 can be stored in the de-jitter buffer 216 by the frame pacer 148. For instance, when network delays cause incomplete frame arrival, the frame pacer 148 can store the available subframe data to maintain continuous processing in the display pipeline. The stored decoded frames 218 can be used and presented on the display 144 by a controller or processing circuit of display system 146. Additionally, a stored subframe of decoded frame 218 can be accessed to adjust the timing of pixel presentation. That is, the stored subframe can include timing data that can be used to align the presentation of one or more (e.g., each) subframes with corresponding display times within the frame. For instance, the timing data can specify that a subframe is to be displayed at 8.33 milliseconds into the frame.

In some embodiments, display 144 can be (or include) a variable refresh rate (VRR) display configured to update the screen when new encoded frames are received. In some embodiments, the refresh rate can be set to 240 Hz (or some other rate). In some instances where the display sets the refresh rate that is different from 240 Hz (e.g., between 239 Hz and 241 Hz, such as 239.9 Hz instead of 240.0 Hz), server computing system 102 can detect this difference and cause the application 110 to render video frames at the rate set by the display (e.g., 239.9 Hz). In some embodiments, the refresh rate can have a different value, e.g., can be between 164 Hz and 166 Hz, between 359 Hz and 361 Hz, or within some other suitable range of frequencies.

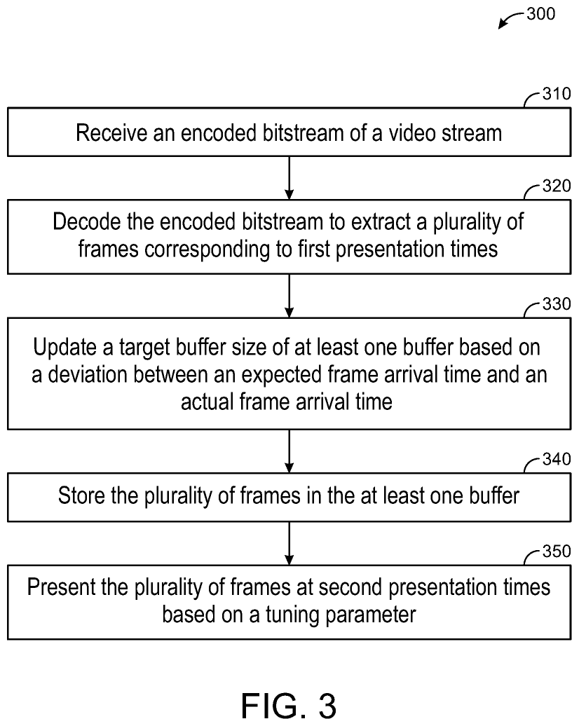

Now referring to FIG. 3, a flow diagram showing a method 300 for buffer sizing and frame pacing, in accordance with some embodiments of the present disclosure. Various operations of the method 300 can be implemented by the same or different devices or entities at various points in time. For instance, one or more first devices can implement operations relating to the dynamic buffer sizing, while one or more second devices can implement operations relating to frame and/or subframe pacing (e.g., while application streaming).

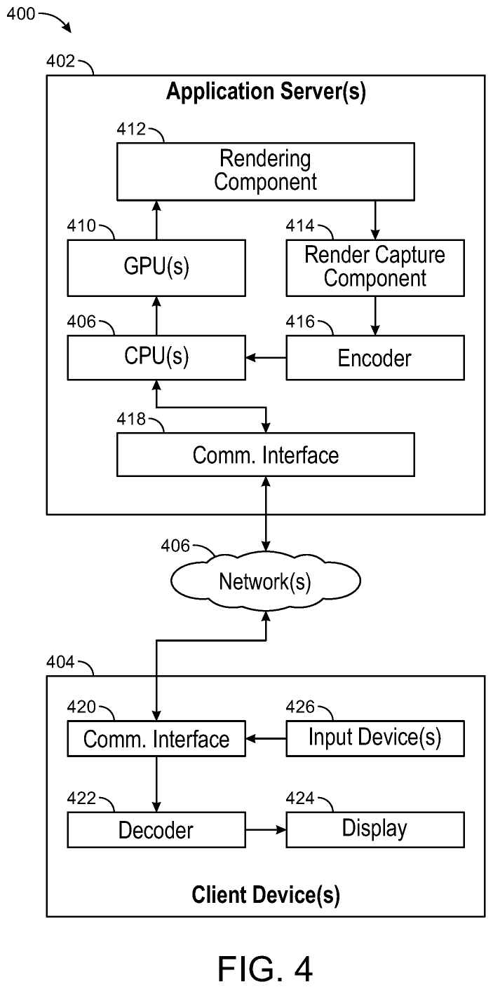

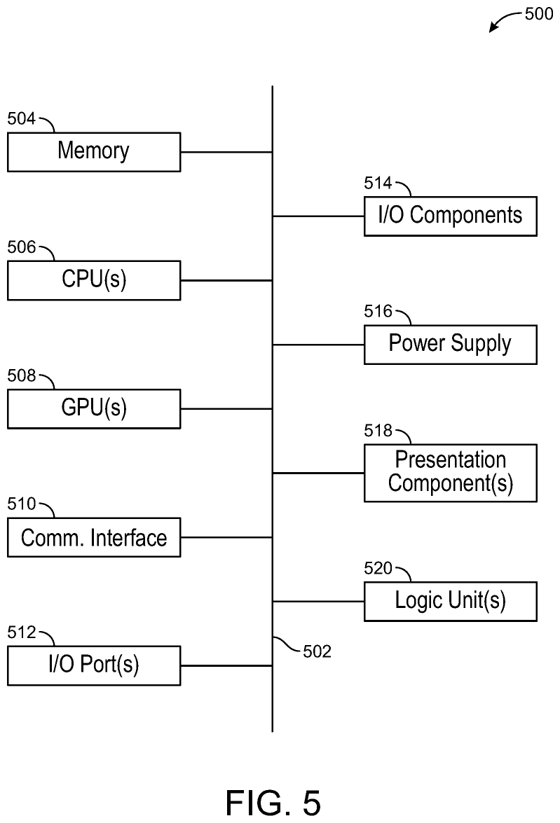

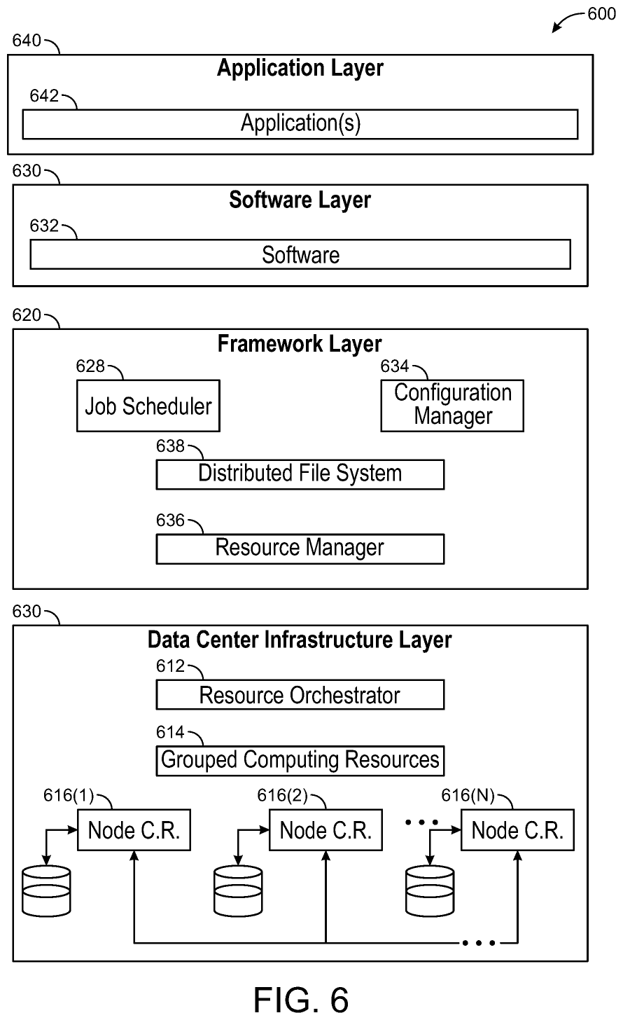

Each block of method 300, described herein, includes a computing process that can be performed using any combination of hardware, firmware, and/or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few. In addition, method 300 is described, by way of example, with respect to the systems of FIG. 1 and frame presentation pipeline of FIG. 2. However, this method can additionally or alternatively be executed by any one system, or any combination of systems, including, but not limited to, those described herein. For instance, in some embodiments, the systems and methods described herein can be implemented using one or more application servers and client devices (e.g., as described in FIG. 4), one or more computing devices (e.g., as described in FIG. 5), and/or one or more data centers (e.g., as described in FIG. 6).

Various operations of method 300 can relate to the dynamic buffer sizing and frame pacing in video streaming or real-time applications. Existing systems often exhibit difficulties in maintaining consistent frame delivery and smooth playback, particularly under variable network conditions. The existing technological problems can arise when buffer sizes are static, causing frame drops, increased latency, and/or synchronization issues. Method 300 and the systems of FIG. 1 and frame presentation pipeline of FIG. 2 can solve these technological problems by dynamically adjusting buffer sizes and applying tuning parameters for frame pacing, thereby optimizing playback performance and reducing latency. This method enhances the overall efficiency and quality of real-time video streaming and frame presentation in varying network environments.

The method 300, at block 310, includes receiving an encoded bitstream of a video stream. For instance, the encoded bitstream can received from a cloud computing system or server. In some embodiments, the encoded bitstream can be transmitted over a network to a client device for processing. That is, the bitstream contains compressed video data that can be decoded and displayed on the client device. For instance, the bitstream can include video data encoded in formats such as H.264, H.265, or AV1. The encoded bitstream received at block 310 may represent compressed video data intended for decoding and subsequent presentation on a display device. It should be understood that while the receipt of the encoded bitstream is described herein as a precursor to decoding, the actual decoding process at block 320 can, in some embodiments, be performed independently of continuous or periodic receipt of new encoded data. That is, the decoding step (block 320) can occur based on previously buffered encoded data or by using alternative data sources already available to the client device. For instance, in some embodiments, pre-decoded or pre-buffered frames may be used.

The method 300, at block 320, includes decoding an encoded bitstream of a data stream to extract a plurality of frames corresponding to a plurality of first presentation times. For instance, the first presentation times can be the originally scheduled times for presentation on the client. In some embodiments, the decoding process can be performed by a hardware decoder or software decoder on the client device. That is, the decoder can extract the frames from the encoded bitstream and prepares them for display. For instance, the decoding can include decompressing the video data and mapping the frames to their respective timestamps.

The method 300, at block 330, includes updating a target buffer size (also referred to herein as an “adaptive buffer size”) of at least one buffer based on one or more deviations between one or more expected frame arrival times of the encoded bitstream and one or more actual frame arrival times. For instance, a network-induced timing variations in frame arrivals can be introduced during the transmission from the server or cloud computing system to the processors of the client device. In some embodiments, the expected arrival time for one or more (e.g., each) of the plurality of frames can be determined by calculating the sum of the timestamp and an estimated network latency. For instance, the estimated network latency can be based on historical round-trip time (RTT) measurements or predefined network parameters (e.g., a network timing metric). That is, the deviation can be a delta (or difference) between when the frame is expected to arrive and when the frame arrives. For instance, the one or more expected frame arrival times can be based on at least one network timing metric. In this instance, the network timing metric can be information or data used to predict network latency, including historical round-trip time (RTT) measurements and/or predefined network parameters. Additionally, the network timing metric can encompass any metrics or models used to forecast latency in a networked environment.

The method 300, at block 340, includes storing the plurality of frames in the at least one buffer for scheduling presentation on a display such as a variable refresh rate (VRR) display. In some embodiments, block 340 includes storing the plurality of frames in an at least one buffer having a dynamic buffer size. In some embodiments, block 340 includes storing the plurality of frames in an at least one buffer having an adaptive buffer size that is responsive to one or more deviations between expected and actual time arrival times of the data stream In some embodiments, the buffer can be a de-jitter buffer configured to store the decoded frames and decoded subframes (e.g., fractional frame data corresponding to partial frame intervals, smaller time-segmented portions of a frame, or inter-frame timing adjustments). That is, the frames and/or subframes can be stored in a dynamically-sized buffer (e.g., regulate consistent frame pacing and/or mitigate or compensate for network-induced timing variations). For instance, the buffer can expand or contract based on real-time network conditions to maintain smooth playback and minimize stutter or latency. In some embodiments, block 340 includes storing subframes of the plurality of frames in the at least one buffer. For instance, the subframes can correspond to one or more portions of at least one of the plurality of frames. That is, the subframes can include timing data that specifies their position within the overall frame timing.

It should be understood that while updating the target buffer size at block 330 is described herein based on deviations between expected and actual frame arrival times, in some embodiments, the process of extracting frames from the encoded bitstream can proceed to storing the plurality of frames in the buffer at block 340 without performing a deviation-based adjustment for each frame. For instance, storing decoded frames in the buffer may be managed using predetermined buffer size settings, historical performance data, or default buffer sizing techniques. Additionally, storing the frames in the buffer at block 340 can initiate an update to the target buffer size, aligning the buffer occupancy with current playback requirements or operational parameters. For instance, block 340 can include storing the plurality of frames in an at least one buffer having an adaptive buffer size that is responsive to one or more deviations between expected and actual time arrival times of the data stream. Thus, the process of storing frames in the buffer can adjust the adaptive buffer size based on varying network conditions or playback states, without performing recalculations of frame arrival deviations at each step. For instance, when frames are stored in a buffer configured with adaptive sizing, the buffer can dynamically expand or contract to accommodate fluctuations in frame arrival rates. In another example, the adaptive buffer size may be adjusted automatically in response to detected trends in frame delivery timing, such as consistent early or late arrivals.

The method 300, at block 350, includes presenting the plurality of frames at a plurality of second presentation times on the display (e.g., VRR) based at least on tuning of the plurality of first presentation times responsive to an update in the target buffer size. That is, the tuning can include using a tuning parameter. In some embodiments, presenting can occur when the final image is ready for presentation (e.g., after UI elements have already been added to the frame—rendered). For instance, the frames can include timestamps, and the computer hardware of the display can update the screen according to the tuned timestamp based on the tuning parameter. That is, the tuning parameter can be a value (e.g., a small delay in milliseconds, an advancement in microseconds) that can be added to the presentation timestamp to delay or advance the presentation. Additionally, the tuning parameter can be derived from the target buffer size to align the buffer occupancy with the target occupancy (e.g., target buffer size). For instance, once a display time is determined (second presentation times) by the VRR display, the tuning parameter can shift (e.g., by a small amount such as, but not limited to, 0.2 ms, 0.5 ms, 1 ms, 2 ms, 5 ms, 10 ms) based on the approximation (or direction) of the de-jitter buffer—growing or shrinking.

In some embodiments, the tuning of the plurality of the first presentation times can be based on timing data of the stored subframes. That is, the timing data can include timecodes or timestamps associated with one or more (e.g., each) subframe segments, specifying the time at which the one or more subframes are to be displayed relative to the start of the frame. For instance, a subframe can have a timestamp indicating it is to be presented exactly 16.67 milliseconds after the start of the frame, aligned with a 60 Hz refresh rate. Additionally, the timing data can include deltas calculated from the deviation between the expected and actual arrival times of the full frame (e.g., of the data stream), facilitating microsecond-level adjustments to align the subframe presentation times with the current buffer state. For instance, if the delta indicates a 2 ms delay in the arrival of a frame, the tuning parameter can be used to adjust the presentation time of one or more subframes within that frame by 2 ms.

In some embodiments, the target buffer size of the at least one buffer can cause an update in a minimum frames per second (FPS) rate based on the one or more deviations in the one or more expected frame arrival times and the one or more actual frame arrival times (e.g., of the data stream). That is, the minimum FPS rate can be adjusted based on the deviation to maintain consistent playback. For instance, if the deviation increases, the minimum FPS rate can be decreased (e.g., by the display system 146) to accommodate longer frame arrival intervals. In some embodiments, the minimum FPS can be adjusted by increasing the buffer size when frame arrival times vary. For instance, an increased buffer size can stabilize frame presentation timing under variable network conditions. Additionally, the adjustment can be applied to prevent underflow or overflow in the de-jitter buffer.

In some embodiments, a maximum FPS rate can be selected based on a streaming mode. That is, the streaming mode can determine the maximum allowable FPS rate to match network and hardware capabilities of the display. For instance, a high-performance mode can select a higher maximum FPS, while a low-bandwidth mode can select a lower maximum FPS. Additionally, the selected maximum FPS rate can be constrained by the capabilities or processing power of the display (e.g., display 144 of display system 146) and/or the processing power of the client device.

In some embodiments, method 300 can include monitoring the one or more deviations and at least one device performance metric (also referred to as a “client performance metric”) of the client device (e.g., device-specific performance indicator, such as processor usage, GPU load, memory bandwidth usage, etc.). That is, the frame arrival variance can be tracked by continuously (or periodically) measuring the deviation between expected and actual frame arrival times. For instance, monitoring the deviations can inform adjustments to the buffer occupancy or presentation timing. Additionally, device performance metrics can be used to assess the current load and/or configuration of the display to handle current processing loads.

In some embodiments, method 300 can include updating the maximum FPS rate based on the monitored one or more deviations. That is, the maximum FPS rate can be adjusted in real-time to reflect current network and buffer conditions. For instance, a decrease in deviation can allow an increase in maximum FPS rate. In some embodiments, method 300 can include updating the maximum FPS rate based on the at least one display performance metric (e.g., frame rate stability, rendering latency, processing throughput). That is, if display performance metrics indicate sufficient processing capacity (e.g., the controller or display chip), the maximum FPS rate can be increased. For instance, increasing the maximum FPS rate can occur when processor usage and network conditions permit. That is, the hardware-assisted frame pacing can use the hardware of the display to adjust the timing of frame presentations. For instance, updates can occur to align with the current buffer occupancy or deviations in frame arrival times. Additionally, while the server or cloud computing system can provide presentation times and presentation rates in the transmitted packets (e.g., encoded bitstream), the controller of the display can independently adjust these times based on real-time factors such as buffer status, network conditions, and display refresh rate, improving the frame presentation to match the current state of the client device.

In some embodiments, the target buffer size of the at least one buffer can be increased to approximate a first buffer size based on the one or more deviations increasing. For instance, this can occur when the final frame presenting speed on the display is slower than the initial intended presenting speed (or rate). That is, the increase in target buffer size can compensate for the slower frame presentation by holding more frames and/or more subframes in the de-jitter buffer to prevent underflow. For instance, the adjustment can facilitate consistent playback despite the slower presentation rate. Additionally, approximation can refer to dynamically sizing the buffer to align (or move towards) the increased or decreased demand for stored frames.

In some embodiments, the target buffer size of the at least one buffer can be decreased to approximate a second buffer size based on the one or more deviations decreasing. For instance, decreasing can occur when the final frame presenting speed on the client device is faster than the initial intended presenting speed (or rate). That is, the decrease in target buffer size can compensate for the faster frame presentation by reducing the number of frames held in the buffer to prevent overflow.

In some embodiments, method 300 can include mapping the plurality of first presentation times of a first computing system to the plurality of second presentation times of the one or more processors. That is, mapping can include synchronizing the presentation times on the display device (e.g., VRR display) with the original times provided by the server or first computing system. The mapping can match the timing sequence and intervals between frames (e.g., starting point). For instance, the client clock and history of frame timestamps can be used to align the second presentation times with the first presentation times (e.g., prior to tuning, if performed). Additionally, mapping can be responsive to decoding the encoded bitstream.

In some embodiments, the plurality of frames presented at the plurality of second presentation times can be presented at a second frame presenting rate. That is, the second presenting rate can be determined by the target buffer size (or occupancy). For instance, the second frame presenting rate can be adjusted based on changes in the target buffer size and/or the tuning parameter. In another instance, the rate can synchronize with the timing deviations detected during frame processing. Additionally, the second frame presenting rate can be modified to maintain smooth playback in response to the updated buffer size.

In some embodiments, the second frame presenting rate is slower or faster than a first frame presenting rate (e.g., rate at which frames are initially intended to be displayed, encoded by the encoder) of the plurality of frames corresponding to the plurality of first presentation times. That is, the second frame presenting rate can be adapted to real-time conditions according to the tuning parameter. For instance, when the tuning parameter indicates a delay, the second frame presenting rate can be slowed down. In some embodiments, method 300 can include adjusting a refresh rate of the VRR display based on the second frame presenting rate. That is, adjusting the refresh rate can include synchronizing the refresh rate of the display with the current frame presenting rate to avoid screen tearing or stutter. For instance, the refresh rate can be lowered if the second frame presenting rate is slower. In another instance, the refresh rate can be increased if the second frame presenting rate is faster.

In some embodiments, the one or more circuits correspond to a display controller of the VRR display. That is, the display controller (or display system) can manage the timing of frame presentations and adjusts the refresh rate accordingly. For instance, the display controller can use the tuning parameter to control the frame pacing (e.g., output timing). In some embodiments, presenting can occur independently of a central processing unit (CPU) of the client device. That is, the display controller can handle frame presentation timing and refresh rate adjustments. For instance, the display control can offload the task (or instructions) of managing frame pacing and presentation timing from the CPU, allowing the display controller to independently adjust the timing based on buffer occupancy (or target buffer occupancy) and the tuning parameter.

In some embodiments, a second presentation time (e.g., when the frame is actually presented) of the plurality of second presentation times can occur before or after a corresponding first presentation time (e.g., when the frame was originally directed for presenting by the encoder) of the plurality of first presentation times provided in the encoded bitstream. That is, the display controller can shift (e.g., adjust by a few milliseconds) the presentation time earlier or later than the original intended presentation time. For instance, when the target buffer size (or occupancy) is smaller (e.g., where the de-jitter buffer dynamically stores less frames and/or less subframes, such as 1-10 frames or 1-10 subframes corresponding to 2.0-4.0 milliseconds of frame data), the display controller can determine a tuning parameter that can shift (delay) the presentation time later to align with actual frame availability (e.g., the tuning parameter can be adjusted by a few milliseconds to ensure smooth playback). In this instance, shifting can cause the occupancy of the de-jitter buffer to dynamically increase as more frames arrive.

Additionally, when the target buffer size (or occupancy) is larger (e.g., where the de-jitter buffer dynamically stores more frames and/or more subframes, such as 8-20 frames or 8-20 subframes corresponding to fractional frame intervals, such as 0.5-2.0 milliseconds of frame data), the display controller can determine a tuning parameter that can shift (advance) the presentation time earlier to reduce latency. In this instance, shifting can cause the occupancy of the de-jitter buffer to dynamically decrease as frames are processed more quickly. While a smaller and larger number of frames are described, it should be understood that the specific frame count can vary depending on the network conditions, processing capabilities, and/or application requirements, and the buffer occupancy can be dynamically adjusted in real-time to optimize playback performance under varying conditions.

### Example Content Streaming System

Now referring to FIG. 4, FIG. 4 is an example system diagram for a system 400, in accordance with some embodiments of the present disclosure. FIG. 4 includes application server(s) 402 (which can include similar components, features, and/or functionality to the example client device 140X or display system 146X of FIGS. 1-2), client device(s) 404 (which can include similar components, features, and/or functionality to the example computing device 500 of FIG. 5), and network(s) 406 (which can be similar to the network(s) described herein). In some embodiments of the present disclosure, the system 400 can be implemented to perform model training/updating and runtime operations. The application session can correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For instance, the system 400 can be implemented to receive input indicating one or more features of output to be generated using a neural network model, provide the input to the model to cause the model to generate the output, and use the output for various operations such as display or simulation operations.

In the system 400, for an application session, the client device(s) 404 can only receive input data in response to inputs to the input device(s), transmit the input data to the application server(s) 402, receive encoded display data from the application server(s) 402, and display the display data on the display 424. As such, the more computationally intense computing and processing is offloaded to the application server(s) 402 (e.g., rendering—in particular ray or path tracing—for graphical output of the application session is executed by the GPU(s) of the game server(s) 402). In other words, the application session is streamed to the client device(s) 404 from the application server(s) 402, thereby reducing the requirements of the client device(s) 404 for graphics processing and rendering.

For instance, with respect to an instantiation of an application session, a client device 404 can be displaying a frame of the application session on the display 424 based on receiving the display data from the application server(s) 402. The client device 404 can receive an input to one of the input device(s) and generate input data in response, such as to provide prompts as input for generation of 3D avatars. The client device 404 can transmit the input data to the application server(s) 402 via the communication interface 420 and over the network(s) 406 (e.g., the Internet—Web2 or Web3), and the application server(s) 402 can receive the input data via the communication interface 418. The CPU(s) can receive the input data, process the input data, and transmit data to the GPU(s) that causes the GPU(s) to generate a rendering of the application session. For instance, the input data can be representative of a movement or animation of a character of the user in a game session of a game application, firing a weapon, reloading, passing a ball, turning a vehicle, etc. The rendering component 412 can render the application session (e.g., representative of the result of the input data) and the render capture component 414 can capture the rendering of the application session as display data (e.g., as image data capturing the rendered frame of the application session). The rendering of the application session can include ray or path-traced lighting and/or shadow effects, computed using one or more parallel processing units—such as GPUs, which can further employ the use of one or more dedicated hardware accelerators or processing cores to perform ray or path-tracing techniques—of the application server(s) 402. In some embodiments, one or more virtual machines (VMs)—e.g., including one or more virtual components, such as vGPUs, vCPUs, etc.—can be used by the application server(s) 402 to support the application sessions. The encoder 416 can then encode the display data to generate encoded display data and the encoded display data can be transmitted to the client device 404 over the network(s) 406 via the communication interface 418. The client device 404 can receive the encoded display data via the communication interface 420 and the decoder 422 can decode the encoded display data to generate the display data. The client device 404 can then display the display data via the display 424.

### Example Computing Device

FIG. 5 is a block diagram of an example computing device(s) 500 suitable for use in implementing some embodiments of the present disclosure. Computing device 500 can include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 can include one or more virtual machines (VMs), and/or any of the components thereof can include virtual components (e.g., virtual hardware components). For non-limiting examples, one or more of the GPUs 508 can include one or more vGPUs, one or more of the CPUs 506 can include one or more vCPUs, and/or one or more of the logic units 520 can include one or more virtual logic units. As such, a computing device(s) 500 can include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For instance, in some embodiments, a presentation component 518, such as a display device, can be considered an I/O component 514 (e.g., if the display is a touch screen). As another example, the CPUs 506 and/or GPUs 508 can include memory (e.g., the memory 504 can be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 can represent one or more links or busses, such as an address bus, a data bus, a control bus, or a combination thereof. The interconnect system 502 can be arranged in various topologies, including but not limited to bus, star, ring, mesh, tree, or hybrid topologies. The interconnect system 502 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 can be directly connected to the memory 504. Further, the CPU 506 can be directly connected to the GPU 508. Where there is direct, or point-to-point connection between components, the interconnect system 502 can include a PCIe link to carry out the connection. In these examples, a PCI bus need not be included in the computing device 500.

The memory 504 can include any of a variety of computer-readable media. The computer-readable media can be any available media that can be accessed by the computing device 500. The computer-readable media can include both volatile and nonvolatile media, and removable and non-removable media. By way of example, and not limitation, the computer-readable media can include computer-storage media and communication media.

The computer-storage media can include both volatile and nonvolatile media and/or removable and non-removable media implemented in any method or technology for storage of information such as computer-readable instructions, data structures, program modules, and/or other data types. For instance, the memory 504 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, quantum memories, or any other medium which can be used to store the desired information and which can be accessed by computing device 500. As used herein, computer storage media does not include signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 506 can be configured to execute at least some of the computer-readable instructions to control one or more components of the computing device 500 to perform one or more of the methods and/or processes described herein. The CPU(s) 506 can each include one or more cores (e.g., one, two, four, eight, twenty-eight, seventy-two, etc.) that are capable of handling a multitude of software threads simultaneously. The CPU(s) 506 can include any type of processor, and can include different types of processors depending on the type of computing device 500 implemented (e.g., processors with fewer cores for mobile devices and processors with more cores for servers). For instance, depending on the type of computing device 500, the processor can be an Advanced RISC Machines (ARM) processor implemented using Reduced Instruction Set Computing (RISC) or an x86 processor implemented using Complex Instruction Set Computing (CISC). The computing device 500 can include one or more CPUs 506 in addition to one or more microprocessors or supplementary co-processors, such as math co-processors.

In addition to or alternatively from the CPU(s) 506, the GPU(s) 508 can be configured to execute at least some of the computer-readable instructions to control one or more components of the computing device 500 to perform one or more of the methods and/or processes described herein. One or more of the GPU(s) 508 can be an integrated GPU (e.g., with one or more of the CPU(s) 506 and/or one or more of the GPU(s) 508 can be a discrete GPU. In embodiments, one or more of the GPU(s) 508 can be a coprocessor of one or more of the CPU(s) 506. The GPU(s) 508 can be used by the computing device 500 to render graphics (e.g., 3D graphics) or perform general purpose computations. For instance, the GPU(s) 508 can be used for General-Purpose computing on GPUs (GPGPU). The GPU(s) 508 can include hundreds or thousands of cores that are capable of handling hundreds or thousands of software threads simultaneously. The GPU(s) 508 can generate pixel data for output images in response to rendering commands (e.g., rendering commands from the CPU(s) 506 received via a host interface). The GPU(s) 508 can include graphics memory, such as display memory, for storing pixel data or any other suitable data, such as GPGPU data. The display memory can be included as part of the memory 504. The GPU(s) 508 can include two or more GPUs operating in parallel (e.g., via a link). The link can directly connect the GPUs (e.g., using NVLINK) or can connect the GPUs through a switch (e.g., using NVSwitch). When combined together, each GPU 508 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 506 and/or the GPU(s) 508, the logic unit(s) 520 can be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 can discretely or jointly perform any combination of the methods, processes and/or portions thereof. One or more of the logic units 520 can be part of and/or integrated in one or more of the CPU(s) 506 and/or the GPU(s) 508 and/or one or more of the logic units 520 can be discrete components or otherwise external to the CPU(s) 506 and/or the GPU(s) 508. In embodiments, one or more of the logic units 520 can be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 can include one or more receivers, transmitters, and/or transceivers that allow the computing device 500 to communicate with other computing devices via an electronic communication network, included wired and/or wireless communications. The communication interface 510 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 can include one or more data processing units (DPUs) to transmit data received over a network and/or through interconnect system 502 directly to (e.g., a memory of) one or more GPU(s) 508. In some embodiments, a plurality of computing devices 500 or components thereof, which can be similar or different to one another in various respects, can be communicatively coupled to transmit and receive data for performing various operations described herein, such as to facilitate latency reduction.

The I/O ports 512 can allow the computing device 500 to be logically coupled to other devices including the I/O components 514, the presentation component(s) 518, and/or other components, some of which can be built in to (e.g., integrated in) the computing device 500. Illustrative I/O components 514 include a microphone, mouse, keyboard, joystick, game pad, game controller, satellite dish, scanner, printer, wireless device, etc. The I/O components 514 can provide a natural user interface (NUI) that processes air gestures, voice, or other physiological inputs generated by a user, such as to generate a prompt, image data, and/or video data. In some instances, inputs can be transmitted to an appropriate network element for further processing, such as to modify and register images. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 can be include depth cameras, such as stereoscopic camera systems, infrared camera systems, RGB camera systems, touchscreen technology, and combinations of these, for gesture detection and recognition. Additionally, the computing device 500 can include accelerometers or gyroscopes (e.g., as part of an inertia measurement unit (IMU)) that allow detection of motion. In some examples, the output of the accelerometers or gyroscopes can be used by the computing device 500 to render immersive augmented reality or virtual reality.

The power supply 516 can include a hard-wired power supply, a battery power supply, or a combination thereof. The power supply 516 can provide power to the computing device 500 to allow the components of the computing device 500 to operate.

The presentation component(s) 518 can include a display (e.g., a monitor, a touch screen, a television screen, a heads-up-display (HUD), other display types, or a combination thereof), speakers, and/or other presentation components. The presentation component(s) 518 can receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that can be used in at least one embodiments of the present disclosure, such as to implement the environment 100 and/or the system 200 in one or more examples of the data center 600. The data center 600 can include a data center infrastructure layer 610, a framework layer 620, a software layer 630, and/or an application layer 640.

As shown in FIG. 6, the data center infrastructure layer 610 can include a resource orchestrator 612, grouped computing resources 614, and node computing resources (“node C.R. s”) 616(1)-616(N), where “N” represents any whole, positive integer. In at least one embodiment, node C.R. s 616(1)-616(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R. s from among node C.R. s 616(1)-616(N) can correspond to a server having one or more of the above-mentioned computing resources. In addition, in some embodiments, the node C.R. s 616(1)-616(N) can include one or more virtual components, such as vGPUs, vCPUs, and/or the like, and/or one or more of the node C.R. s 616(1)-616(N) can correspond to a virtual machine (VM).

In at least one embodiment, grouped computing resources 614 can include separate groupings of node C.R. s 616 housed within one or more racks (not shown), or many racks housed in data centers at various geographical locations (also not shown). Separate groupings of node C.R. s 616 within grouped computing resources 614 can include grouped compute, network, memory or storage resources that can be configured or allocated to support one or more workloads. In at least one embodiment, several node C.R. s 616 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 612 can configure or otherwise control one or more node C.R. s 616(1)-616(N) and/or grouped computing resources 614. In at least one embodiment, resource orchestrator 612 can include a software design infrastructure (SDI) management entity for the data center 600. The resource orchestrator 612 can include hardware, software, or some combination thereof.

In at least one embodiment, as shown in FIG. 6, framework layer 620 can include a job scheduler 628, a configuration manager 634, a resource manager 636, and/or a distributed file system 638. The framework layer 620 can include a framework to support software 632 of software layer 630 and/or one or more application(s) 642 of application layer 640. The software 632 or application(s) 642 can respectively include web-based service software or applications, such as those provided by Amazon Web Services, Google Cloud and Microsoft Azure. The framework layer 620 can be, but is not limited to, a type of free and open-source software web application framework such as Apache Spark™ (hereinafter “Spark”) that can utilize distributed file system 638 for large-scale data processing (e.g., “big data”). In at least one embodiment, job scheduler 628 can include a Spark driver to facilitate scheduling of workloads supported by various layers of data center 600. The configuration manager 634 can be capable of configuring different layers such as software layer 630 and framework layer 620 including Spark and distributed file system 638 for supporting large-scale data processing. The resource manager 636 can be capable of managing clustered or grouped computing resources mapped to or allocated for support of distributed file system 638 and job scheduler 628. In at least one embodiment, clustered or grouped computing resources can include grouped computing resource 614 at data center infrastructure layer 610. The resource manager 636 can coordinate with resource orchestrator 612 to manage these mapped or allocated computing resources.

In at least one embodiment, software 632 included in software layer 630 can include software used by at least portions of node C.R. s 616(1)-616(N), grouped computing resources 614, and/or distributed file system 638 of framework layer 620. One or more types of software can include, but are not limited to, Internet web page search software, e-mail virus scan software, database software, and streaming video content software.

In at least one embodiment, application(s) 642 included in application layer 640 can include one or more types of applications used by at least portions of node C.R. s 616(1)-616(N), grouped computing resources 614, and/or distributed file system 638 of framework layer 620. One or more types of applications can include, but are not limited to, any number of a genomics application, a cognitive compute, and a machine learning application, including training/updating or inferencing software, machine learning framework software (e.g., PyTorch, TensorFlow, Caffe, etc.), and/or other machine learning applications used in conjunction with one or more embodiments, such as to train, configure, update, and/or execute machine learning models.

In at least one embodiment, any of configuration manager 634, resource manager 636, and resource orchestrator 612 can implement any number and type of self-modifying actions based on any amount and type of data acquired in any technically feasible fashion. Self-modifying actions can relieve a data center operator of data center 600 from making possibly bad configuration decisions and possibly avoiding underutilized and/or poor performing portions of a data center.

The data center 600 can include tools, services, software or other resources to train/update one or more machine learning models (e.g., train/update machine learning models) or predict or infer information using one or more machine learning models (e.g., to generate a large language model) according to one or more embodiments described herein. For instance, a machine learning model(s) can be trained/updated by calculating weight parameters according to a neural network architecture using software and/or computing resources described above with respect to the data center 600. In at least one embodiment, trained/updated or deployed machine learning models corresponding to one or more neural networks can be used to infer or predict information using resources described above with respect to the data center 600 by using weight parameters calculated through one or more training/updating techniques, such as but not limited to those described herein.

In at least one embodiment, the data center 600 can use CPUs, application-specific integrated circuits (ASICs), GPUs, FPGAs, and/or other hardware (or virtual compute resources corresponding thereto) to perform training/updating and/or inferencing using above-described resources. Moreover, one or more software and/or hardware resources described above can be configured as a service to allow users to train/update or perform inferencing of information, such as image recognition, speech recognition, or other artificial intelligence services.

### Example Network Environments

Network environments suitable for use in implementing embodiments of the disclosure can include one or more client devices, servers, network attached storage (NAS), other backend devices, and/or other device types. The client devices, servers, and/or other device types (e.g., each device) can be implemented on one or more instances of the computing device(s) 500 of FIG. 5- e.g., each device can include similar components, features, and/or functionality of the computing device(s) 500. In addition, where backend devices (e.g., servers, NAS, etc.) are implemented, the backend devices can be included as part of a data center 600, an example of which is described in more detail herein with respect to FIG. 6.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments - in which case a server cannot be included in a network environment - and one or more client-server network environments - in which case one or more servers can be included in a network environment. In peer-to-peer network environments, functionality described herein with respect to a server(s) can be implemented on any number of client devices.

In at least one embodiment, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In embodiments, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 500 described herein with respect to FIG. 5. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, a holographic display, a biometric authentication device, a quantum computing device, a neuroenhancement headset, an augmented reality glasses, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For instance, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors, comprising:
one or more circuits to:
decode an encoded bitstream of a data stream to extract a plurality of frames corresponding to a plurality of first presentation times;
update a target buffer size of at least one buffer based on one or more deviations between one or more expected frame arrival times of the encoded bitstream and one or more actual frame arrival times;
store the plurality of frames in the at least one buffer for scheduling presentation on a display; and
present the plurality of frames at a plurality of second presentation times on the display based on at least one tuning of the plurality of first presentation times responsive to an update in the target buffer size.

2. The one or more processors of claim 1, wherein:
the target buffer size of the at least one buffer causes an update in a minimum frames per second (FPS) rate based on the one or more deviations in the one or more expected frame arrival times and the one or more actual frame arrival times; and
a maximum FPS rate is selected based on a streaming mode.

3. The one or more processors of claim 2, wherein the one or more circuits are to:
monitor the one or more deviations and at least one display performance metric of the display; and
update the maximum FPS rate based on at least one of (i) the monitored one or more deviations or (ii) the at least one display performance metric.

4. The one or more processors of claim 2, wherein:
the target buffer size of the at least one buffer is increased to approximate a first buffer size based on the one or more deviations increasing; and
the target buffer size of the at least one buffer is decreased to approximate a second buffer size based on the one or more deviations decreasing.

5. The one or more processors of claim 1, wherein the one or more circuits are to:
responsive to decoding the encoded bitstream, map the plurality of first presentation times of a first computing system to the plurality of second presentation times of the one or more processors.

6. The one or more processors of claim 1, wherein:
the plurality of frames presented at the plurality of second presentation times is presented at a second frame presenting rate; and
the second frame presenting rate is slower or faster than a first frame presenting rate of the plurality of frames corresponding to the plurality of first presentation times.

7. The one or more processors of claim 6, wherein the one or more circuits are to:
adjust a refresh rate of the display based on the second frame presenting rate.

8. The one or more processors of claim 1, wherein:
the one or more circuits correspond to a display controller of the display; and
the presenting occurs independently of a central processing unit (CPU) of a client device.

9. The one or more processors of claim 1, wherein:
a second presentation time of the plurality of second presentation times occurs before or after a corresponding first presentation time of the plurality of first presentation times provided in the encoded bitstream.

10. The one or more processors of claim 1, wherein the one or more circuits are to:
store subframes of the plurality of frames in the at least one buffer, the subframes corresponding to one or more portions of at least one of the plurality of frames; and
wherein the tuning of the plurality of first presentation times is based on timing data of the stored subframes.

11. The one or more processors of claim 1, wherein the one or more processors are comprised in at least one of:
a system for performing gaming;
a system for performing content streaming;
a system for performing collaborative content creation;
a system for performing simulation operations;
a system for performing collaborative content creation for 3D assets;
a system for generating synthetic data;
a system comprising one or more vision language models (VLMs);
a system comprising one or more large language models (LLMs);
a system for performing conversational AI operations;
a system for performing light transport simulation;
a system for performing deep learning operations;
a system for performing digital twin operations;
a control system for an autonomous or semi-autonomous machine;
a perception system for an autonomous or semi-autonomous machine;
a system incorporating one or more virtual machines (VMs);
a system implemented using a robot;
a system implemented using an edge device;
a system implemented at least partially in a data center; or
a system implemented at least partially using cloud computing resources.

12. A system, comprising:
one or more processors to execute operations comprising:
extract, from a data stream, a plurality of frames corresponding to a plurality of first presentation times;
store the plurality of frames in an at least one buffer having an adaptive buffer size that is responsive to one or more deviations between expected and actual time arrival times of the data stream; and
present the plurality of frames at a plurality of second presentation times on a display based on at least one tuning of the plurality of first presentation times responsive to an update in the adaptive buffer size.

13. The system of claim 12, wherein:
the adaptive buffer size of the at least one buffer causes an update in a minimum frames per second (FPS) rate based on the one or more deviations between the expected and the actual arrival times of the data stream; and
a maximum FPS rate is selected based on a streaming mode.

14. The system of claim 13, wherein the operations further comprise:
monitor the one or more deviations and at least one display performance metric of the display; and
update the maximum FPS rate based on at least one of (i) the monitored one or more deviations or (ii) the at least one display performance metric.

15. The system of claim 13, wherein:
the adaptive buffer size of the at least one buffer is increased to approximate a first buffer size based on the one or more deviations increasing; and
the adaptive buffer size of the at least one buffer is decreased to approximate a second buffer size based on the one or more deviations decreasing.

16. The system of claim 12, wherein the operations further comprise:
decode an encoded bitstream of the data stream to extract the plurality of frames; and
responsive to decoding the encoded bitstream, map the plurality of first presentation times of a first computing system to the plurality of second presentation times of the system.

17. The system of claim 12, wherein:
the plurality of frames presented at the plurality of second presentation times is presented at a second frame presenting rate; and
the second frame presenting rate is slower or faster than a first frame presenting rate of the plurality of frames corresponding to the plurality of first presentation times.

18. The system of claim 17, wherein the operations further comprise:
adjust a refresh rate of the display based on the second frame presenting rate.

19. The system of claim 12, wherein:
the one or more processors correspond to a display controller of the display; and
the presenting occurs independently of a central processing unit (CPU) of a client device.

20. A method, comprising:
decoding an encoded bitstream of a data stream to extract a plurality of frames corresponding to a plurality of first presentation times;
storing, using one or more processors, the plurality of frames in an at least one buffer having a dynamic buffer size; and
presenting, using the one or more processors, the plurality of frames at a plurality of second presentation times on a display based on at least one adjustment of the plurality of first presentation times responsive to an update in the dynamic buffer size and variations between predicted and actual frame arrival times of the data stream.
